(19) United States
(12) Patent Application Publication
(10) Pub. No.: US 2024/0034595 A1
(43) Pub. Date: Feb. 1, 2024

(54) STATE ESTIMATION APPARATUS FOR BRAKE APPARATUS FOR HOISTING MACHINE, STATE ESTIMATION SYSTEM, BRAKE SYSTEM FOR HOISTING MACHINE, ELEVATOR MAINTENANCE SYSTEM, NON-TRANSITORY STORAGE MEDIUM, AND STATE ESTIMATION METHOD

(71) Applicant: KABUSHIKI KAISHA TOSHIBA, Tokyo (JP)

(72) Inventor: Yoshinori MORI, Kawasaki Kanagawa (JP)

(73) Assignee: KABUSHIKI KAISHA TOSHIBA, Tokyo (JP)

(21) Appl. No.: 18/172,936

(22) Filed: Feb. 22, 2023

(30) Foreign Application Priority Data
Jul. 28, 2022 (JP) 2022-120751

(51) Int. Cl. B66B 5/00; B66B 5/18

(52) U.S. Cl. CPC B66B 5/0025; B66B 5/18

(57) ABSTRACT

According to an embodiment, a state estimation apparatus for a brake apparatus for a hoisting machine, includes a processor. The processor is configured to acquire waveform information of an elastic wave generated in a case where a brake material fixed to a brake plate connected to a rotation shaft of the hoisting machine and a metal plate holding the brake material and restraining movement of the brake plate come into contact with each other using a sensor provided on the metal plate; and estimate at least one of a surface state of the brake material, a surface state of the metal plate, and a contact state between the brake material and the metal plate based on a feature amount of the waveform information.

### CROSS-REFERENCE TO RELATED APPLICATIONS

This application is based upon and claims the benefit of priority from Japanese Patent Application No. 2022-120751, filed Jul. 28, 2022, the entire contents of all of which are incorporated herein by reference.

### FIELD

Embodiments of the present invention relate to a state estimation apparatus for a brake apparatus for a hoisting machine used in an elevator, a state estimation system, a brake system for a hoisting machine, an elevator maintenance system, a non-transitory storage medium, and a state estimation method.

### BACKGROUND

A hoisting machine used in an elevator is an apparatus that winds up a rope with a sheave fixed to a rotation shaft until a car reaches a designated floor. A brake apparatus for a hoisting machine plays a role of a holding brake that fixes the movement of the car on a designated floor and a braking brake that stops the car descending in an emergency. For example, a non-excited operation type electromagnetic brake is used in this brake apparatus, and a torque (frictional force) is generated by a force of a spring during a brake operation.

### BRIEF DESCRIPTION OF THE DRAWINGS

FIG. 1 is a schematic perspective diagram illustrating an overall configuration of an elevator.

FIG. 2 is a schematic diagram illustrating an overall configuration of a hoisting machine for an elevator according to a first embodiment.

FIG. 3 is a schematic diagram of a brake apparatus (disc brake) of the hoisting machine illustrated in FIG. 2 as viewed from a direction indicated by reference sign III in FIG. 2.

FIG. 4 is a cross-sectional diagram taken along line A-A in FIG. 3 in a case where a brake of the brake apparatus illustrated in FIG. 3 is in a closed position.

FIG. 5 is a cross-sectional diagram taken along line A-A in FIG. 3 in a case where the brake of the brake apparatus illustrated in FIG. 3 is in an open position.

FIG. 6 is a diagram illustrating a cross section of the brake apparatus illustrated in FIG. 4 taken along line VI-VI and a side surface of a bracket.

FIG. 7 is a diagram illustrating a cross section of the brake apparatus illustrated in FIG. 4 taken along line VI-VI and a side surface of the armature.

FIG. 8 is a graph showing a time-dependent decrease in holding/braking torque (brake performance) of a general brake apparatus.

FIG. 9 is a schematic block diagram illustrating an elevator maintenance system.

FIG. 10 is examples of elastic wave signals (waveform information) that can be detected by sensors illustrated in FIGS. 6 and 7.

FIG. 11 is an example of a flowchart used in a case where state estimation processing of the brake apparatus for a hoisting machine is performed.

FIG. 12 is a schematic diagram illustrating a part of a brake apparatus (drum brake) for a hoisting machine for an elevator according to a second embodiment.

FIG. 13 is a diagram illustrating an example of a sensor installation portion as viewed from a direction indicated by an arrow XIII in the brake apparatus illustrated in FIG. 12.

### DETAILED DESCRIPTION

An object of an embodiment is to provide a state estimation apparatus for a brake apparatus for a hoisting machine, a state estimation system, a brake system for a hoisting machine, an elevator maintenance system, a non-transitory storage medium configured to store a state estimation program, and a state estimation method capable of grasping deterioration in performance over time, an inspection timing, and a replacement timing of the brake apparatus for a hoisting machine used in an elevator.

According to the embodiment, a state estimation apparatus for a brake apparatus for a hoisting machine, includes a processor. The processor is configured to acquire waveform information of an elastic wave generated in a case where a brake material fixed to a brake plate connected to a rotation shaft of the hoisting machine and a metal plate holding the brake material and restraining movement of the brake plate come into contact with each other using a sensor provided on the metal plate; and estimate at least one of a surface state of the brake material, a surface state of the metal plate, and a contact state between the brake material and the metal plate based on a feature amount of the waveform information.

Various embodiments will be described hereinafter with reference to the accompanying drawings.

### First Embodiment

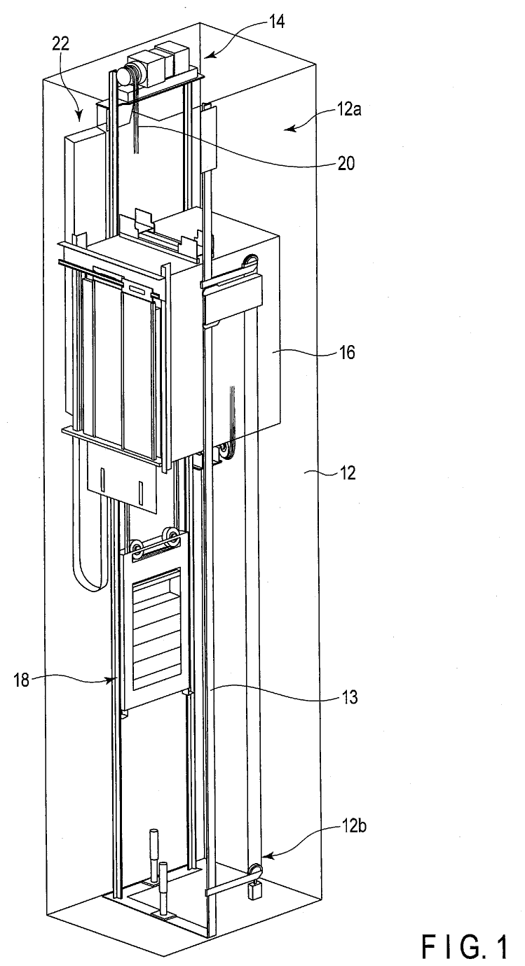

An elevator maintenance system 94 according to a first embodiment will be described with reference to FIGS. 1 to 11.

FIG. 1 is a schematic perspective diagram illustrating an overall configuration of an elevator (elevating machine) 10.

As illustrated in FIG. 1, the elevator 10 includes a hoistway 12, a hoisting machine 14, a car 16, a balance weight 18, a rope 20, and a control apparatus 22.

The car 16 and the balance weight 18 are connected by a rope 20 wound around a sheave 32 described later of the hoisting machine 14. The hoisting machine 14 is arranged, for example, at an overhead 12a above the hoistway 12. The car 16 moves up and down along a guide rail 13 provided in the hoistway 12 in response to winding up/release of the rope 20 fixed via the sheave 32 of the hoisting machine 14.

The car 16 moves between the overhead 12a above the hoistway 12 and a pit 12b below the hoistway. Note that the hoisting machine 14 may be arranged in the pit 12b.

The control apparatus 22 is configured to control, for example, rotation of a rotation shaft 14a (described later) of the hoisting machine 14 and opening and closing of a brake apparatus (a brake apparatus for a hoisting machine) 34.

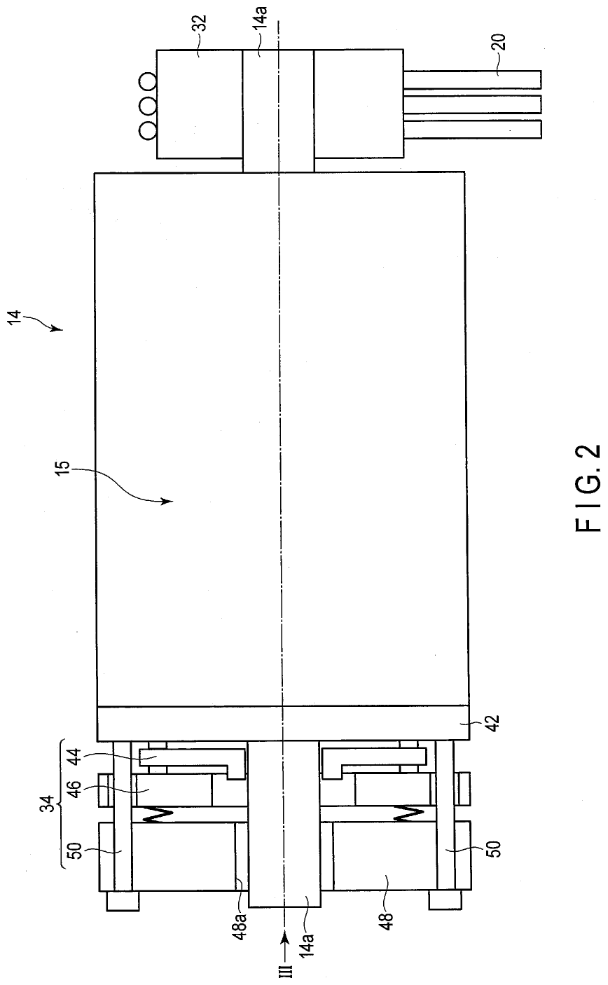

FIG. 2 illustrates a schematic structure of the hoisting machine 14 used in the elevator 10.

The hoisting machine 14 includes a motor (not illustrated) whose rotation shaft 14a is rotated by supply of power. The rotation direction of the rotation shaft 14a is two directions. Then, the drive and stop of the rotation shaft 14a of the motor are controlled by the control apparatus 22 illustrated in FIG. 1. In a case where a direction of going in and out of the car 16 of the elevator 10 is the front-rear direction, the rotation shaft 14a of the motor of the hoisting machine 14 protrudes from end portions (left end portion and right end portion) in the left-right direction horizontally intersecting the front-rear direction with respect to a frame 15 in which the motor is arranged inside. The sheave 32 to which the rope 20 is hooked is installed on one side of the rotation shaft 14a, and a brake apparatus 34 is installed on the other side of the rotation shaft 14a.

The rope 20 is wound around the sheave 32 of the hoisting machine 14. Therefore, in a case where the sheave 32 rotates together with the rotation shaft 14a by the rotation of the rotation shaft 14a, the car 16 hung on the rope 20 moves up and down in a predetermined range in the hoistway 12.

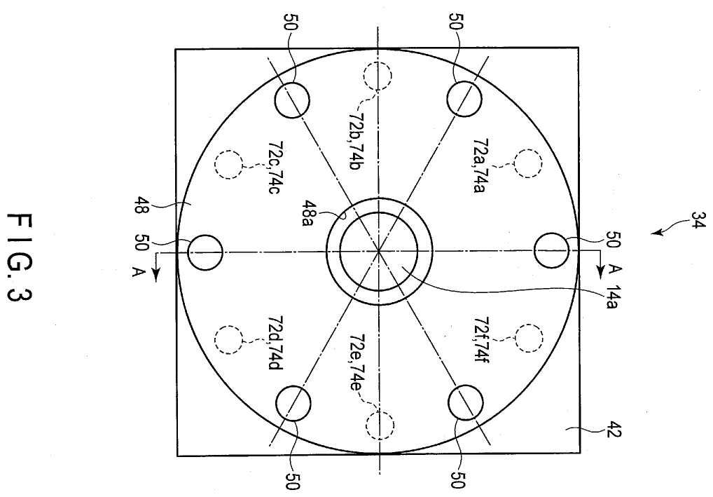

FIGS. 3 to 7 illustrate a structure of the brake apparatus 34.

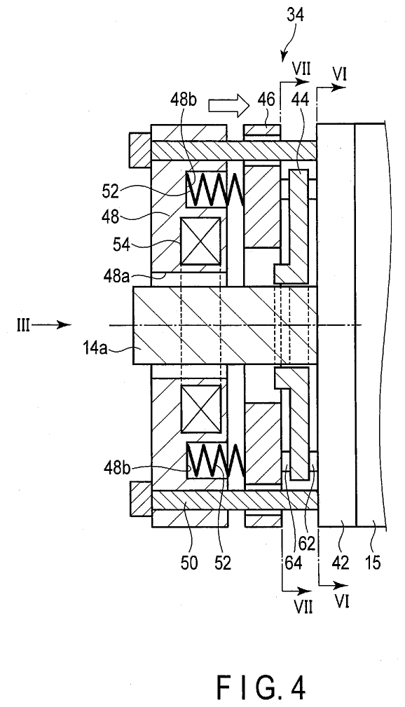

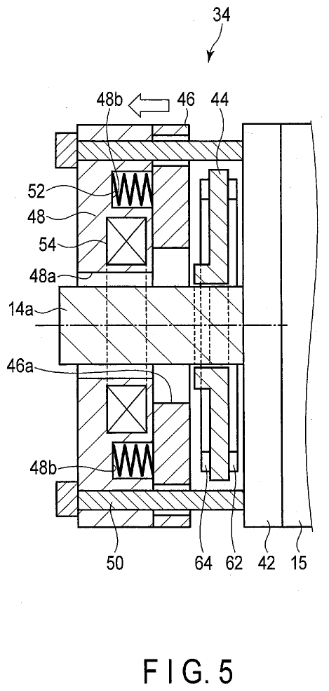

FIG. 3 is a schematic diagram of the brake apparatus (disc brake) 34 of the hoisting machine 14 illustrated in FIG. 2 as viewed from a direction indicated by reference sign III in FIG. 2. FIG. 4 is a cross-sectional diagram taken along line A-A in FIG. 3 in a case where the brake of the brake apparatus 34 illustrated in FIG. 3 is in the closed position. FIG. 5 is a cross-sectional diagram taken along line A-A in FIG. 3 in a case where the brake of the brake apparatus 34 illustrated in FIG. 3 is in the open position.

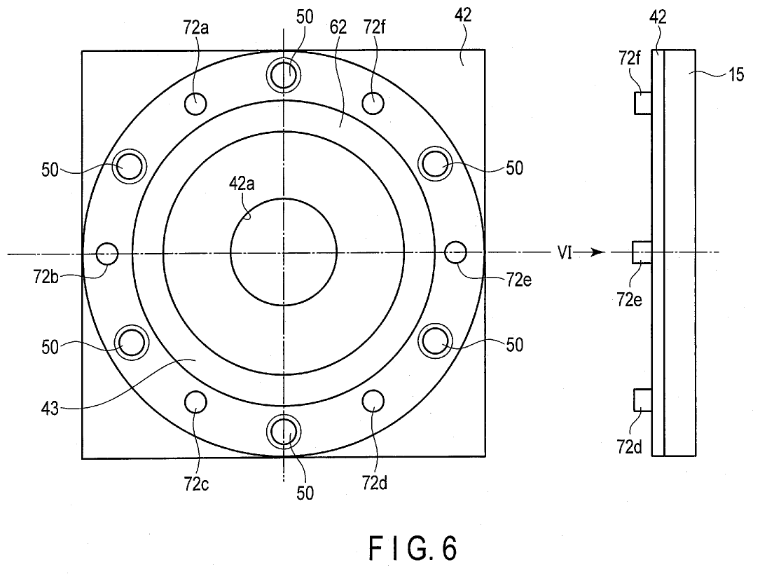

The left diagram of FIG. 6 is a cross-sectional diagram taken along line VI-VI in FIG. 4, and the right diagram of FIG. 6 is a diagram illustrating a state in which sensors 72a to 72f are arranged in the bracket 42 illustrated in FIG. 4. The right diagram in FIG. 6 is the left diagram in FIG. 6 as viewed from the direction indicated by the arrow VI.

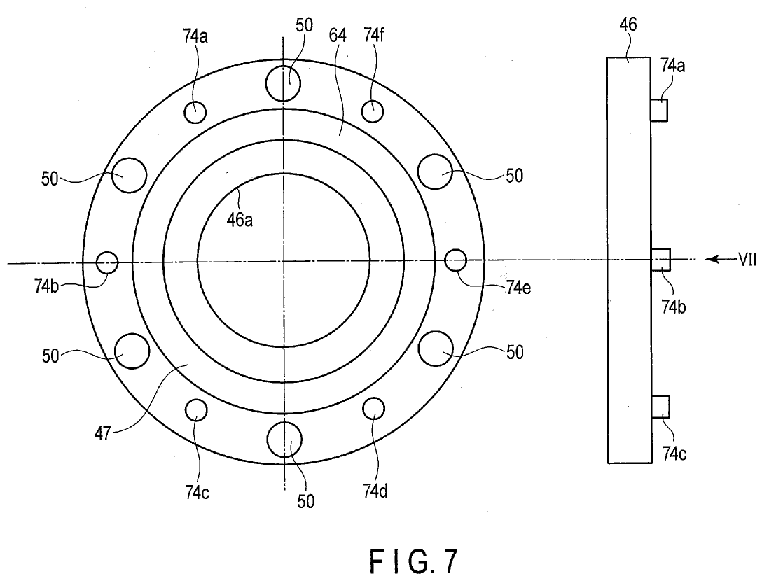

The left diagram of FIG. 7 is a cross-sectional diagram taken along line VII-VII in FIG. 4, and the right diagram of FIG. 7 is a diagram illustrating a state in which sensors 74a to 74f are arranged in the bracket 42 illustrated in FIG. 4. The right diagram in FIG. 7 is the left diagram in FIG. 7 as viewed from the direction indicated by the arrow VII.

The brake apparatus 34 includes a bracket 42, a disk-shaped brake plate 44, an armature 46, a coil case 48, fastening bolts 50, biasing bodies 52, and an electromagnetic coil 54.

The bracket 42 is formed in, for example, a rectangular plate shape or a disk shape. The bracket 42 is fixed to the frame 15 on which the motor of the hoisting machine 14 is arranged. The rotation shaft 14a protrudes from an opening 42a at the center of the bracket 42.

The brake plate 44 is arranged at a position facing the bracket 42. The brake plate 44 is formed in a disk shape. The brake plate 44 is connected to the rotation shaft 14a of the hoisting machine 14 via a spline. Therefore, in a case where the rotation shaft 14a rotates, the brake plate 44 rotates together in the same direction. The brake plate 44 can move in the axial direction of the rotation shaft 14a. The brake plate 44 is formed of a magnetic material, or a disk-shaped magnetic material, for example, is fixed to the brake plate 44.

The armature 46 faces the side of the brake plate 44 opposite to the bracket 42. The armature 46 is formed in a disk shape having an opening 46a through which the rotation shaft 14a passes. The armature 46 is formed of a magnetic body, or a disk-shaped magnetic body, for example, is fixed to the armature 46.

The coil case 48 faces the side of the armature 46 opposite to the brake plate 44. The coil case 48 is formed in a disk shape having an opening 48a through which the rotation shaft 14a passes.

The plurality of fastening bolts 50 are parallel to the rotation shaft 14a, penetrate the coil case 48 and the armature 46, and are fixed to the bracket 42. Therefore, the plurality of fastening bolts 50 restrict the movement of the armature 46 and the coil case 48 in the rotational direction.

For example, an appropriate gap is provided between the plurality of fastening bolts 50 and the armature 46. Thus, the armature 46 is movable within a predetermined range in the axial direction of the fastening bolt 50.

In addition, the plurality of fastening bolts 50 are arranged at positions on the outer side farther from the central axis of the rotation shaft 14a than the outer edge of the brake plate 44. Therefore, the plurality of fastening bolts 50 do not restrict the rotation of the brake plate 44.

A first brake pad (brake material) 62 is fixed to the brake plate 44 on the bracket 42 side. A second brake pad (brake material) 64 is fixed to the armature 46 side. For this reason, the brake pads 62 and 64 are provided on both surfaces of the brake plate 44. The first pad 62 and the second pad 64 are preferably formed in annular shapes having the same material, the same shape, the same size, and the same thickness.

In the coil case 48, for example, a plurality of support portions 48b each having a concave shape for supporting one end of each of the plurality of biasing bodies 52 are formed. The support portions 48b are formed at equal intervals in the circumferential direction on the circumference where the coil case 48 concentric with the central axis of the rotation shaft 14a exists. The support portions 48b are recessed holes in which an opening is formed on the armature 46 side. The biasing body 52 is arranged in each support portion 48b. That is, between the armature 46 and the coil case 48, a plurality of biasing bodies 52 are arranged at equal intervals on a predetermined circumference. Therefore, the armature 46 is biased toward the brake plate 44 by the plurality of biasing bodies 52. For example, compression coil springs are preferably used as the plurality of biasing bodies 52. Therefore, the biasing bodies 52 normally makes contact between the bracket 42 and the first pad 62 and between the armature 46 and the second pad 64.

The electromagnetic coil 54 having an annular shape is installed in the coil case 48. For example, the electromagnetic coil 54 is installed at a position inside a predetermined circumference of the support portions 48b on which the biasing body 52 is arranged. In a case where the electromagnetic coil 54 is energized, the armature 46 and the brake plate 44 are electromagnetically attracted to the coil case 48 side and pulled. Therefore, in a case where the electromagnetic coil 54 is energized, the bracket 42 and the first pad 62 are separated from each other. The movement of the brake plate 44 toward the coil case 48 is restricted by, for example, a restricting member (not illustrated) provided between the inside of the opening 46a of the armature 46 and the outer peripheral surface of the rotation shaft 14a. Therefore, in a case where the electromagnetic coil 54 is energized, the bracket 42 and the first pad 62 are separated from each other, and the armature 46 and the second pad 64 are separated from each other.

In a case where the energization to the electromagnetic coil 54 is stopped, the armature 46 moves toward the brake plate 44 by the biasing force of the biasing bodies 52. Therefore, the portion between the bracket 42 and the first pad 62 and the portion between the armature 46 and the second pad 64 are pressed, and the friction force between the bracket 42 and the first pad 62 and the friction force between the armature 46 and the second pad 64 brake the rotation of the brake plate 44.

As illustrated in FIG. 6, the bracket 42 is preferably provided with a plurality of sensors 72a to 72f. In the present embodiment, the sensors 72a to 72f are provided between the fastening bolts 50, respectively. Each of the sensors 72a to 72f is provided, for example, on the brake plate 44 side (first pad 62 side). Each of the sensors 72a to 72f is installed avoiding a region 43 where the first brake pad 62 is in contact with the bracket 42. FIG. 6 illustrates an example in which each of the sensors 72a to 72f is installed outside a region 43 of the bracket 42 with which the first brake pad 62 is in contact. It is also preferable that each of the sensors 72a to 72f is installed inside the region 43 of the bracket 42 with which the first brake pad 62 is in contact. In a case where each of the sensors 72a to 72f is installed outside the region 43 of the bracket 42 with which the first brake pad 62 is in contact, the wiring of each of the sensors 72a to 72f is easily arranged outside the bracket 42, and maintenance of each of the sensors 72a to 72f is easy.

As illustrated in FIG. 7, the armature 46 is preferably provided with the plurality of sensors 74a to 74f. In the present embodiment, the sensors 74a to 74f are provided between the fastening bolts 50, respectively. Each of the sensors 74a to 74f is provided, for example, on the brake plate 44 side (second pad 64 side). Each of the sensors 74a to 74f is installed avoiding a region 47 where the second brake pad 64 is in contact with the armature 46. FIG. 7 illustrates an example in which each of the sensors 74a to 74f is installed outside the region 47 of the armature 46 with which the second brake pad 64 is in contact. It is also preferable that each of the sensors 74a to 74f is installed inside the region 47 of the armature 46 with which the second brake pad 64 is in contact. In a case where each of the sensors 74a to 74f is installed outside the region 47 of the armature 46 with which the second brake pad 64 is in contact, the wiring of each of the sensors 74a to 74f is easily arranged outside the armature 46, and maintenance of each of the sensors 74a to 74f is easy.

The sensors 72a to 72f and 74a to 74f are desirably installed at equal intervals in the vicinity of the regions 43 and 47 where either the bracket 42 or the armature 46 or both the brake pads 62 and 64 are in contact with each other.

In the present embodiment, the sensors 72a to 72f and 74a to 74f are installed at positions equidistant from the central axis of the rotation shaft 14a, for example, at intervals of 60°. Further, the sensors 72a to 72f and 74a to 74f are arranged at positions separated from the fastening bolts 50, such as the centers between the fastening bolts 50. The number of the sensors 72a to 72f and 74a to 74f can be set as appropriate. As illustrated in FIG. 3, the pair of sensors 72a and 74a spaced apart in the axial direction of the rotation shaft 14a are preferably arranged at positions overlapping in the axial direction. Similarly, the pair of sensors 72b and 74b, the pair of sensors 72c and 74c, the pair of sensors 72d and 74d, the pair of sensors 72e and 74e, and the pair of sensors 72f and 74f are preferably arranged at positions overlapping in the axial direction.

The number of sensors 72a to 72f and 74a to 74f can be adjusted by, for example, the number of fastening bolts 50.

As the sensors 72a to 72f and 74a to 74f, for example, NANO 30 which is an AE sensor manufactured by Physical Acoustics can be used. In addition to the AE sensor or instead of the AE sensor, a vibration sensor that detects a vibration change such as at least one of displacement, speed, and acceleration of an object may be used as the sensors 72a to 72f and 74a to 74f.

Each of the sensors 72a to 72f and 74a to 74f is controlled by, for example, the control apparatus 22.

The control apparatus 22 includes, for example, a computer and the like, and includes a processor (processing circuit) and a storage medium. The processor includes any of a central processing unit (CPU), an application specific integrated circuit (ASIC), a microcomputer, a field programmable gate array (FPGA), a digital signal processor (DSP), and the like. The storage medium may include an auxiliary storage apparatus in addition to a main storage apparatus such as a memory. Examples of the storage medium include a hard disk drive (HDD), a solid state drive (SSD), a magnetic disk, an optical disk (CD-ROM, CD-R, DVD, etc.), a magneto-optical disk (MO or the like), and a non-volatile memory capable of writing and reading at any time, such as a semiconductor memory.

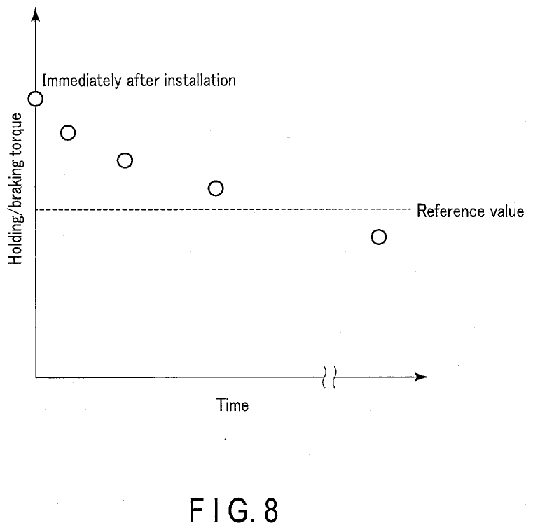

In the brake apparatus 34, it is known that the holding/braking torque tends to change (decrease) with time as shown in FIG. 8. This is considered to be because the frictional force on the contact surface between the first brake pad 62 and the bracket 42 and the contact surface between the second pad 64 and the armature 46 decreases.

Normally, the holding/braking torque falls below the reference value (safety line) several years after installation of the hoisting machine 14 or replacement of the brake apparatus 34. It is preferable to maintain or replace the brake apparatus 34 before the holding/braking torque falls below the reference value. At present, in a case where the above-described performance falls below the reference value in a periodic inspection of the brake apparatus 34, a measure for replacing the brake apparatus 34 is required.

Some cases where the frictional force between the brake pad 62 and the bracket 42 and between the brake pad 64 and the armature 46 decreases will be listed below.
(1) The brake pads 62 and 64 or the mating material (the bracket 42 or the armature 46) is unevenly worn, and the contact area decreases.
(2) The physical properties of the brake pads 62 and 64 change, and the substantial contact ratio in the contact area with the mating material (the bracket 42 or the armature 46) decreases.
(3) Foreign matter is mixed in a contact surface between the brake pads 62 and 64 and a mating material (the bracket 42 or the armature 46).
(4) The mating material (the bracket 42 or the armature 46) rusts to increase the surface roughness.

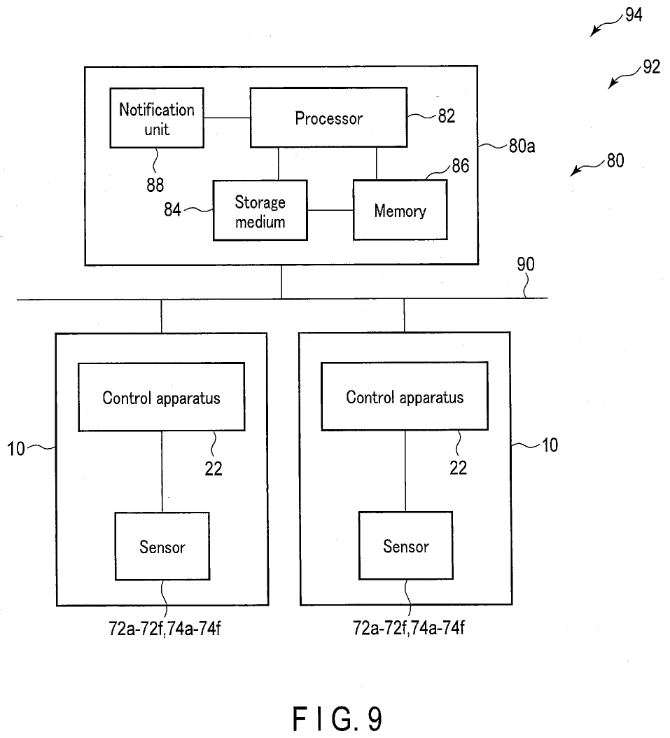

FIG. 9 illustrates a schematic block diagram illustrating an elevator maintenance system 94. As illustrated in FIG. 9, a state estimation system 80 as a management system for the brake apparatus 34 for the hoisting machine 14 according to the present embodiment includes the sensors 72a to 72f and 74a to 74f attached to the brake apparatus 34, the control apparatus 22 that controls the sensors 72a to 72f and 74a to 74f, and a management server 80a as a state estimation apparatus of the brake apparatus 34 for the hoisting machine 14 that communicates with the control apparatus 22 in a wired or wireless manner. Note that the control of the sensors 72a to 72f and 74a to 74f may be performed by the control apparatus 22, or may be performed by the management server 80a, for example, remotely.

In the management server 80a, for example, a plurality of elevators 10 are connected via a communication network 90 such as the Internet or an intranet.

The management server 80a acquires waveform information from the sensors 72a to 72f and 74a to 74f controlled by the control apparatus 22 of each elevator and estimates at least one of the surface states of the brake pads 62 and 64, the bracket 42, and the armature 46, the contact state between the brake pad 62 and the bracket 42, and the contact state between the brake pad 64 and the armature 46, based on the feature amount of the waveform information.

The management server 80a includes a processor 82, a non-transitory storage medium (auxiliary storage apparatus) 84, a memory 86, and a notification unit 88.

The processor 82 includes any of a central processing unit (CPU), an application specific integrated circuit (ASIC), a microcomputer, a field programmable gate array (FPGA), a digital signal processor (DSP), and the like. The processor 82 is used as a controller that controls the entire management server 80a.

The storage medium 84 is a nonvolatile memory such as an HDD, an SSD, or a flash memory. The storage medium 84 may further include a volatile memory. For example, a cloud memory may be used as the storage medium 84.

The memory 86 includes, for example, a volatile semiconductor memory. The memory 86 is also used as a work memory of the processor 82.

The storage medium 84 stores, for example, various programs. For example, the processor 82 writes and executes various programs stored in the storage medium 84 in the memory 86, thereby exerting a function according to the program.

The various programs are not necessarily stored in the storage medium 84, and the processor 82 can cause the various programs to be executed on a server via a network.

The storage medium 84 stores, for example, a state estimation program or algorithm of the brake apparatus 34 according to the present embodiment and a signal processing program corresponding to the setting of each of the sensors 72a to 72f and 74a to 74f. The state estimation program of the brake apparatus 34 may be stored in the ROM.

The state estimation program of the brake apparatus 34 may be installed in advance in the management server 80a, may be stored in a nonvolatile storage medium, or may be distributed via a network. The state estimation program of the brake apparatus 34 may be outside the management server 80a, for example, an appropriate server. That is, for the execution of the state estimation program, a state estimation program of a server different from the management server 80a may be used, or all the processing of the state estimation program may be executed inside the management server 80a.

The storage medium 84 is used as a database configured to store waveform information acquired from each of the sensors 72a to 72f and 74a to 74f, and a state estimation result output by comparing the waveform information with reference data.

In the management server 80a, only one processor 82 and only one storage medium 84 may be provided, or a plurality of processors 82 and a plurality of storage media 84 may be provided. In the management server 80a, the processor 82 performs processing by executing a program or the like stored in the storage medium 84 or the like. Furthermore, the program executed by the processor 82 of the management server 80a may be stored in a computer (server) different from the management server 80a, a server in a cloud environment, or the like via a network such as the Internet. In this case, the processor 82 downloads the program via the network. In the management server 80a, arithmetic processing of comparing the waveform information acquired using each of the sensors 72a to 72f and 74a to 74f with the reference data is executed by the processor 82 or the like, and the arithmetic processing result is stored in the storage medium 84 together with the waveform information acquired using each of the sensors 72a to 72f and 74a to 74f.

Furthermore, at least part of the processing by the processor 82 may be executed by a cloud server configured in a cloud environment. The infrastructure of the cloud environment includes a virtual processor such as a virtual CPU and a cloud memory. In one example, acquisition of waveform information from the sensors 72a to 72f and 74a to 74f and various types of calculation processing based on the waveform information acquired from the sensors 72a to 72f and 74a to 74f are executed by the virtual processor, and the cloud memory functions as a data storage unit.

The notification unit 88 can display the waveform information acquired by each of the sensors 72a to 72f and 74a to 74f of each elevator 10, and a comparison arithmetic result with reference data obtained based on the waveform information on, for example, a display or the like. Note that the notification unit 88 can display information of a sensor among the sensors 72a to 72f and 74a to 74f attached to the brake apparatus 34 for the hoisting machine 14 of the elevator 10 in which the problem has occurred, and information of a portion where the problem is estimated to have occurred in the brake apparatus 34. In addition to using a display, the notification unit 88 may notify a building management company, a maintenance company of the elevator 10, a manufacturer of the elevator 10 (brake apparatus 34), or the like of various types of information by sound or light emission.

In the storage medium 84 of the management server 80a, for example, waveform information acquired by each of the sensors 72a to 72f and 74a to 74f in a case where the holding/braking torque exceeds the reference value shown in FIG. 8 is accumulated, and waveform information acquired by each of the sensors 72a to 72f and 74a to 74f in a case where the holding/braking torque falls below the reference value shown in FIG. 8 is accumulated. The waveform information acquired by each of the sensors 72a to 72f and 74a to 74f in a case where the holding/braking torque falls below the reference value shown in FIG. 8 can be experimentally acquired by, for example, a manufacturer of the elevator 10 or the like by performing, for example, a fatigue test or the like.

It is assumed that, due to the use of the elevator 10, that is, the use of the hoisting machine 14, as the years elapse from the installation of the hoisting machine 14 or the replacement of the brake apparatus 34, the amplitude of the elastic wave becomes smaller and the frequency becomes higher than those of the reference data as the feature amount of the waveform information of the elastic wave. Using the feature amount of the waveform information, the processor 82 of the management server sets in advance the correspondence relationship between the feature amount of the waveform information assumed to be acquired by each of the sensors 72a to 72f and 74a to 74f and the holding/braking torque, and stores the correspondence relationship in the storage medium 84.

Therefore, the processor 82 of the management server 80a can output whether the brake apparatus 34 exceeds the reference value of the holding/braking torque or the margin of the holding/braking torque with respect to the reference value based on the waveform information acquired by each of the sensors 72a to 72f and 74a to 74f. Therefore, the processor 82 of the management server estimates at least one of the surface states of the brake pads 62 and 64 and the bracket 42, the surface state of the armature 46, the contact state between the brake pad 62 and the bracket 42, and the contact state between the brake pad 64 and the armature 46 based on the feature amount of the waveform information. More specifically, the processor 82 of the management server can estimate the surface state of the brake pad 62, the surface state of the bracket 42, and the contact state between the brake pad 62 and the bracket 42 based on the feature amount of the waveform information acquired by the sensors 72a to 72f. In addition, the processor 82 of the management server 80a can estimate the surface state of the brake pad 64, the surface state of the armature 46, and the contact state between the brake pad 64 and the armature 46 based on the feature amount of the waveform information acquired by the sensors 74a to 74f.

The brake apparatus 34 and the management system (state estimation system) 80 for the hoisting machine 14 can form a brake system 92 for the hoisting machine 14.

The brake apparatus 34 and the management system (state estimation system) 80 for the hoisting machine 14 can form an elevator maintenance system 94 including the brake system 92 for the hoisting machine 14.

Hereinafter, a state estimation processing of the brake apparatus 34 for the hoisting machine 14 using the elevator maintenance system 94 will be described.

In a case of moving the car 16 up and down, the hoisting machine 14 rotates the rotation shaft 14a to feed out the rope 20 from the sheave 32 or wind the rope 20 around the sheave 32. At this time, the brake apparatus 34 applies a current to the electromagnetic coil 54 built in the coil case 48, and rotates the rotation shaft 14a in an appropriate direction while causing the electromagnetic coil 54 to attract the armature 46.

In a case of stopping the car 16 at a desired floor, the hoisting machine 14 interrupts power supply for rotation of the rotation shaft 14a and stops application of a current to the electromagnetic coil 54 incorporated in the coil case 48. The brake apparatus 34 generates frictional force between the first brake pad 62 of the brake plate 44 and the bracket 42 and between the second brake pad 64 of the brake plate 44 and the armature 46 while releasing the armature 46 from the electromagnetic coil 54. Then, the brake apparatus 34 maintains the car 16 in a state of being stopped at a predetermined position of a desired floor.

As described above, the brake apparatus 34 operates by attracting/releasing the armature 46 depending on the presence or absence of the electromagnetic force generated in a case where the current is applied to the electromagnetic coil 54 built in the coil case 48. The biasing bodies 52 are incorporated in the coil case 48. In a case where the electromagnetic attractive force becomes 0, the restoring force of the biasing bodies 52 acts on the armature 46 to press the brake plate 44 against the bracket 42. The brake plate 44 is connected to the rotation shaft 14a of the hoisting machine 14 via a spline. Therefore, the rotation shaft 14a of the hoisting machine 14 is fixed by restraining the brake plate 44.

In a case where the car 16 that moves up and down in the up-down direction is stopped, as illustrated in FIG. 4, the first brake pad 62 comes into contact with the contact region 43 of the bracket 42, and the second brake pad 64 comes into contact with the contact region 47 of the armature 46. The sensors 72a to 72f detect sound (vibration) at the time of contact and during contact between the first brake pad 62 and the contact region 43 of the bracket 42, respectively. Similarly, the sensors 74a to 74f detect sound (vibration) at the time of contact and during contact between the second brake pad 64 and the contact region 47 of the armature 46.

Note that the detection triggers of the sensors 72a to 72f and 74a to 74f can be set as appropriate. For example, the management server 80a or the control apparatus 22 may acquire the waveform information by the sensors 72a to 72f and 74a to 74f by using stop of energization to the electromagnetic coil 54 as a trigger.

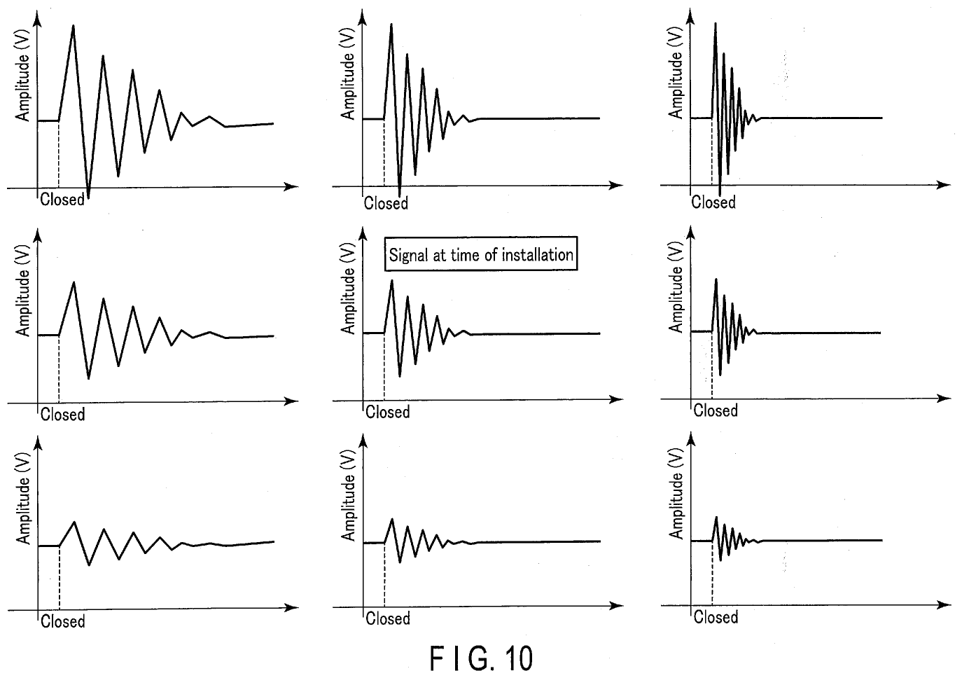

The management server (state estimation apparatus of the brake apparatus 34 for the hoisting machine 14) 80a acquires the waveform information by each of the sensors 72a to 72f and 74a to 74f via the control apparatus 22. For example, the waveform information as shown in FIG. 10 is acquired by each of the sensors 72a to 72f and 74a to 74f. The length (time) of acquiring the waveform information from the input signal of the trigger in each of the sensors 72a to 72f and 74a to 74f can be set as appropriate. The management server 80a acquires the waveform information, for example, for several milliseconds from the input of the trigger. In this case, in a case where the waveform information is acquired by each of the sensors 72a to 72f and 74a to 74f, for example, it is possible to prevent reflected waves from the outer edge portion of the bracket 42 and the outer edge portion of the armature 46 from being detected as the waveform information.

For example, the management server 80a uses the waveform information obtained by each of the sensors 72a to 72f and 74a to 74f immediately after installation of the hoisting machine 14 or immediately after replacement of the brake apparatus 34 for the hoisting machine 14 as a reference waveform, that is, reference data at the time of installation of the hoisting machine 14 or replacement of the brake apparatus 34. The management server 80a stores the reference data of each of the sensors 72a to 72f and 74a to 74f in the storage medium 84 or the like.

Normally, the positional relationship between the bracket 42 and the brake plate 44 of the brake apparatus 34 and the positional relationship between the brake plate 44 and the armature 46 are different between the case where the car 16 stops on a first designated floor designated by a first user and the case where the car 16 stops on a second designated floor designated by a second user. Therefore, the contact positional relationship (phase) between the bracket 42 and the brake plate 44 of the brake apparatus 34 and the contact positional relationship (phase) between the brake plate 44 and the armature 46 are not necessarily the same.

Therefore, the management server 80a acquires the waveform information of each of the sensors 72a to 72f and 74a to 74f in a case where the car 16 is stopped on each floor, stores the waveform information in the storage medium 84 or the like, and compares the waveform information with the reference data. In the present embodiment, since the brake apparatus 34 includes the 12 sensors 72a to 72f and 74a to 74f, the management server 80a causes the storage medium 84 or the like to store the reference data of the number of floors on which the car 16 can stop×12.

Note that the car 16 may stop on the first designated floor such as the first floor of the building, stop on another floor such as the second floor of the building, and then stop on the first designated floor again. At this time, the contact positional relationship (phase) between the bracket 42 and the brake plate 44 of the brake apparatus 34 for the hoisting machine 14 and the contact positional relationship (phase) between the brake plate 44 and the armature 46 on the first designated floor (for example, the first floor) are substantially constant.

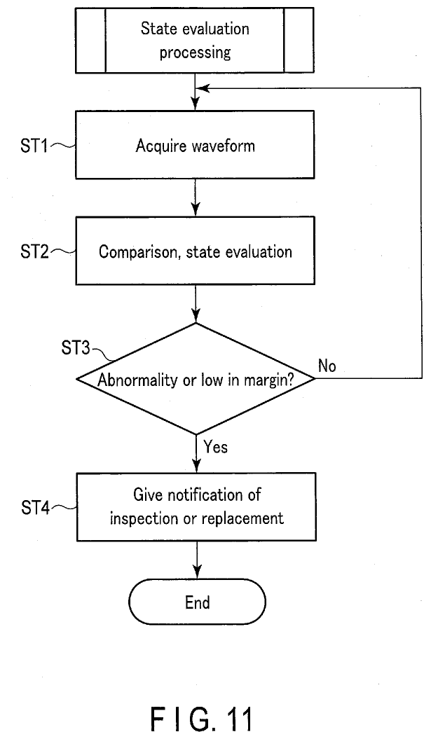

Next, a state estimation processing method of the brake apparatus 34, that is, a method of determining necessity of inspection/replacement of the brake apparatus 34 will be described with reference to a flowchart illustrated in FIG. 11. Here, for example, the management server 80a estimates whether or not the holding/braking torque exceeds the reference value and the margin with respect to the reference value. If possible, the management server 80a estimates an abnormal portion of the brake apparatus 34.

The management server 80a acquires the waveform information by each of the sensors 72a to 72f and 74a to 74f every time the car 16 stops at an appropriate floor desired by the user, stores the waveform information in the storage medium 84 or the like together with the acquisition time, and accumulates the waveform information (step ST1).

The management server 80a compares the waveform information acquired by each of the sensors 72a to 72f and 74a to 74f with the reference data of each of the sensors 72a to 72f and 74a to 74f on each floor.

The use of the elevator 10, that is, the use of the hoisting machine 14 can change the states of the contact surfaces between the first pad 62 and the bracket 42 and between the second pad 64 and the armature 46 as years elapse from the installation of the hoisting machine 14 or from the replacement of the brake apparatus 34. Such a change is considered to change the feature amount of the waveform information (elastic wave) acquired by each of the sensors 72a to 72f and 74a to 74f. Examples of the feature amount include an amplitude change, a frequency change, a delay in arrival time, and the like (see FIG. 10). In addition, it is considered that a peak frequency and a centroid frequency of a power spectrum obtained by performing frequency analysis (FFT analysis) on waveform information (elastic wave signal) also change according to a change in the state of the contact surface. Such a change (change amount) is calculated using the processor 82 of the management server 80a, and the possibility of performance degradation of the brake plate 44, the bracket 42, and the armature 46 is output (step ST2). For example, in a case where at least one of the amplitude change, the frequency change, the delay of the arrival time, and the change in the peak frequency and the centroid frequency of the power spectrum obtained by the frequency analysis (FFT analysis) of the elastic wave signal described above changes beyond a certain threshold, the processor 82 of the management server 80a outputs to the notification unit 88 that there is a possibility that an abnormality occurs in the brake apparatus 34, for example.

As described above, the management server (state estimation apparatus) 80a uses the magnitude and the frequency of the amplitude of the elastic wave acquired by the sensors 72a to 72f and 74a to 74f as the feature amount of the waveform information of the elastic wave, and estimates the contact state between the first pad 62 and the bracket (metal plate) 42 and the contact state between the second pad 64 and the armature (metal plate) 46 from the difference from the reference data acquired at the time of installation of the hoisting machine 14 or at the time of replacement of the brake apparatus 34. That is, the management server 80a estimates a change in the surface state between the first pad 62 and the bracket (metal plate) 42 and/or the surface state between the second pad 64 and the armature (metal plate) 46 based on the feature amount of the waveform information.

In addition, the management server 80a estimates the lowering state of the holding/braking torque from the relationship between the feature amount of the waveform information acquired by each of the sensors 72a to 72f and 74a to 74f and the feature amount of the waveform information stored in the storage medium 84, and estimates whether or not the current performance of the brake apparatus 34 exceeds the reference value of the holding/braking torque. That is, the processor 82 of the management server 80a estimates the state of the brake apparatus 34. This estimation result is stored in the storage medium 84 with time, for example.

In a case where the processor 82 of the management server 80a estimates that the current performance of the brake apparatus 34 exceeds the reference value of the holding/braking torque, the processor 82 notifies the notification unit 88 of the margin. This margin is preferably set in a plurality of stages.

In a case where the margin is high and the current performance of the brake apparatus 34 has a margin with respect to the reference value of the holding/braking torque (step ST3—No), the elevator 10 can be used as usual. Therefore, the management server stands by for new waveform acquisition in each of the sensors 72a to 72f and 74a to 74f (stop of the car 16 at another position).

In this manner, the management server 80a can obtain the information regarding the brake apparatus 34 for the hoisting machine 14 of the elevator 10 every time the car 16 of the elevator 10 stops and repeatedly estimate the state of the brake apparatus 34.

In a case where the processor 82 of the management server 80a estimates that the current performance of the brake apparatus 34 exceeds the reference value of the holding/braking torque and that the margin is low (step ST3—Yes), the processor 82 notifies the notification unit 88 (step ST4). In the notification content from the processor 82 of the management server 80a to the notification unit 88 at this time, the performance of the brake apparatus 34 is close to the reference value of the holding/braking torque, and it is necessary to inspect or replace the brake apparatus 34. Therefore, the maintenance company of the elevator 10 can arrange to inspect or replace the brake apparatus 34, for example, in the near future.

There may be a case where the processor 82 of the management server 80a estimates that the current performance of the brake apparatus 34 falls below the reference value of the holding/braking torque (step ST3—Yes). In this case, the processor 82 of the management server 80a notifies the notification unit 88 (step ST4). In the notification content from the processor 82 of the management server 80a to the notification unit 88 at this time, the performance of the brake apparatus 34 falls below the reference value of the holding/braking torque, and it is necessary to stop the operation of the elevator 10 and inspect or replace the brake apparatus 34 on the same day. In a case where the processor 82 of the management server 80a estimates that the current performance of the brake apparatus 34 falls below the reference value of the holding/braking torque, the control apparatus 22 may maintain the car 16 in a state of being stopped and end the processing of the management server 80a, or may promptly stop the use of the elevator 10 and inspect the state of the brake apparatus 34 after all the users currently riding in the car 16 get off.

Note that the notification destination by the notification unit 88 of the management server 80a is, for example, a management company of the building in which the elevator 10 is installed, a maintenance company of the elevator 10, and/or a manufacturer of the elevator 10 (brake apparatus 34). In this case, the management company of the building in which the elevator 10 is installed, the maintenance company of the elevator 10 or the manufacturer of the elevator 10 (brake apparatus 34) stops the use of the elevator 10, for example, inspects the state of the brake apparatus 34, and replaces it as necessary.

For example, it is assumed that the car 16 stops at a predetermined position on the first floor, for example. At this time, it is assumed that the processor 82 of the management server 80a outputs that a signal determined to be abnormal for the reference data is detected by, for example, a certain sensor 72a fixed to the bracket 42. In a case where the feature amount of the waveform information acquired by the sensor 72a is determined to be abnormal again at another arrival floor such as the second floor and is not changed, the processor 82 of the management server 80a can determine that there is a problem with the bracket 42 (step ST3—Yes) because the positional relationship between the bracket 42 and the sensors 72a to 72f is in the fixed state. In this case, the processor 82 of the management server 80a causes the notification unit 88 to display that a problem has occurred in the bracket 42 (step ST4). Therefore, it is possible to notify the notification unit 88 of the portion where the problem occurs in the brake apparatus 34, separately from whether or not the holding/braking torque is close to the reference value. As described above, for example, the processor 82 of the management server 80a can estimate the problem portion occurring in the brake apparatus 34 based on not only the waveform information in a case where the car 16 stops on one floor but also the waveform information in a case where the car 16 stops on a plurality of floors.

The processor 82 of the management server (state estimation apparatus) 80a can determine whether the states of the brake pads (brake materials) 62 and 64 are changing or the states of the bracket 42 and/or the armature 46 in contact with the brake pads (brake materials) 62 and 64 are changing based on the waveform information acquired by the sensors 72a to 72f and 74a to 74f, based on the continuity of the accumulated waveform information.

As described above, the reference data of the waveform information for each of the sensors 72a to 72f and 74a to 74f changes for each arrival floor. Therefore, in a case where the feature amount of the waveform information of each of the sensors 72a to 72f and 74a to 74f changes with respect to the reference data at another arrival floor such as the second floor, it is unclear whether there is a problem on the brake plate 44 side or the bracket 42.

It is known that the surfaces of the pads (friction materials) 62 and 64 of the brake plate 44 after the fatigue test simulating the ON/OFF operation of the brake apparatus 34 are harder than a new friction material. In addition, it is assumed that the mechanical characteristics of the surfaces of the pads (friction materials) 62 and 64 of the brake plate 44 change depending on the temperature and humidity change after installation of the hoisting machine 14, the history of emergency braking, and the like. The state estimation apparatus 80a of the brake apparatus 34 for the hoisting machine 14 according to the present embodiment can monitor the state change of the brake apparatus 34 at a fine cycle by detecting these feature amounts for each ON/OFF operation of the brake apparatus 34.

As described above, the management system 80 according to the present embodiment transmits the waveform information acquired by the sensors 72a to 72f and 74a to 74f installed in the brake apparatus 34 for the hoisting machine 14 at a brake-closed position by the brake apparatus 34 to the management server 80a via the control apparatus 22 of the elevator 10, and stores the waveform information received from the sensors 72a to 72f and 74a to 74f by the management server 80a in the database, and executes the state estimation processing of comparing with the reference data. In a case where a specific numerical value among the numerical values calculated based on the difference between the reference data and the waveform information acquired by the sensors 72a to 72f and 74a to 74f exceeds or falls below the threshold value, the management server 80a notifies the building management company, the maintenance company of the elevator 10, and the like of the replacement timing of the brake apparatus 34 for the hoisting machine 14 through, for example, the notification unit 88.

In addition, the state estimation program of the brake apparatus 34 for the hoisting machine 14 according to the present embodiment acquires the waveform information acquired in a case where the sensors 72a to 72f and 74a to 74f attached to the brake apparatus 34 are at the brake-closed positions by the management server 80a via the control apparatus 22, stores the waveform information received from the control apparatus 22 by the management server 80a in the database, and executes the state estimation processing of comparing with the reference data. In a case where a specific numerical value among the numerical values calculated based on the difference between the reference data and the waveform information acquired by the sensors 72a to 72f and 74a to 74f exceeds or falls below the threshold value, the management server 80a notifies the notification unit 88, for example, of the replacement timing of the brake apparatus 34 for the hoisting machine 14.

Note that the management server 80a described above can use, for example, a server of a management company of the elevator 10, and the management company can obtain information regarding the brake apparatus 34 for the hoisting machine 14 of the elevator 10 managed by itself every time the car 16 of the elevator 10 stops, and repeatedly perform state estimation of the brake apparatus 34.

The management server 80a can obtain the waveform information from each of the sensors 72a to 72f and 74a to 74f every time the car 16 of the elevator 10 stops. Therefore, the management server 80a can accumulate the waveform information for a continuous period from the installation of the hoisting machine 14 or the replacement of the brake apparatus 34, and can estimate the state of the brake apparatus 34 based on the waveform information obtained every time the car 16 stops.

In the present embodiment, an example has been described in which the processor 82 of the management server 80a sets in advance the correspondence relationship between the feature amount of the waveform information assumed to be acquired by each of the sensors 72a to 72f and 74a to 74f and the holding/braking torque, and stores the correspondence relationship in the storage medium 84. For example, it is assumed that the management server 80a has artificial intelligence. In this case, every time the processor 82 of the management server 80a obtains the waveform information by each of the sensors 72a to 72f and 74a to 74f via the control apparatus 22, machine learning such as deep learning may be performed, and the correspondence relationship between the feature amount of the waveform information and the holding/braking torque may be set as appropriate. That is, in a case where the correspondence relationship between the waveform information and the holding/braking torque is set, the management server 80a can use, for example, an algorithm of machine learning using artificial intelligence.

For example, at the time of replacing the brake apparatus 34 for the hoisting machine 14 in each elevator 10, the management server 80a can verify the correspondence relationship between the feature amount of the waveform information and the holding/braking torque and accumulate the data in the management server 80a. In addition, the management server 80a can update the correspondence relationship between the feature amount of the waveform information and the holding/braking torque based on the output result of the machine learning using the data.

In the present embodiment, the waveform information obtained by the sensors 72a to 72f and 74a to 74f in a case where the car 16 is stopped on each floor at the time of installation of the hoisting machine 14 or replacement of the brake apparatus 34 is used as the reference data. One reference data acquired within an appropriate period immediately after installation of the hoisting machine 14 or replacement of the brake apparatus 34 may be set. In each of the sensors 72a to 72f and 74a to 74f, a plurality of pieces of waveform information acquired on the same first floor may be used as reference data. In this case, a plurality of pieces of reference data can be provided for each of the sensors 72a to 72f and 74a to 74f.

In the present embodiment, an example in which the six sensors 72a to 72f are arranged on the bracket 42 has been described. The number of sensors arranged on the bracket 42 is preferably plural, but may be one. In addition, an example in which the six sensors 74a to 74f are arranged on the armature 46 has been described. The number of sensors arranged on the armature 46 is preferably plural, but may be one.

In the present embodiment, from the time of installation of the hoisting machine 14 or replacement of the brake apparatus 34 in the elevator 10, the plurality of sensors 72a to 72f are installed on the bracket 42, which is a metal body in contact with the brake pad (friction material) 62 of the brake apparatus 34, and the plurality of sensors 74a to 74f are installed on the armature 46, which is a metal body in contact with the brake pad 64. In a case where the car 16 reaches a predetermined floor and the brake is operated, elastic waves generated by solid contact between the brake pad 62 and the bracket 42 and solid contact between the brake pad 64 and the armature 46 are recorded. Then, the feature amounts of these elastic waves acquired and recorded by the sensors 72a to 72f and 74a to 74f are compared with reference data at the time of installation of the hoisting machine 14 or replacement of the brake apparatus 34. As a result, according to the present embodiment, it is possible to estimate the state of the brake apparatus 34 and evaluate the state of the brake apparatus 34 every time the brake apparatus 34 is turned on/off, which is a steady operation, without requiring an unsteady brake braking operation.

According to the present embodiment, it is possible to provide the state estimation apparatus 80a of the brake apparatus 34 for the hoisting machine 14, the state estimation system 80, the brake system 92 for the hoisting machine 14, the elevator maintenance system 94, the non-transitory storage medium configured to store a state estimation program, and the state estimation method capable of grasping the deterioration in performance over time, the inspection timing, and the replacement timing of the brake apparatus 34 for the hoisting machine 14 used in the elevator 10 so as to maintain the brake apparatus 34 such as inspecting and replacing the brake apparatus 34 before the holding/braking torque of the brake apparatus 34 for the hoisting machine 14 of the elevator 10 falls below a reference value (safety line).

### Second Embodiment

An elevator maintenance system 94 according to a second embodiment will be described. The elevator maintenance system 94 according to the second embodiment is different from the elevator maintenance system 94 according to the first embodiment in the arrangement of sensors.

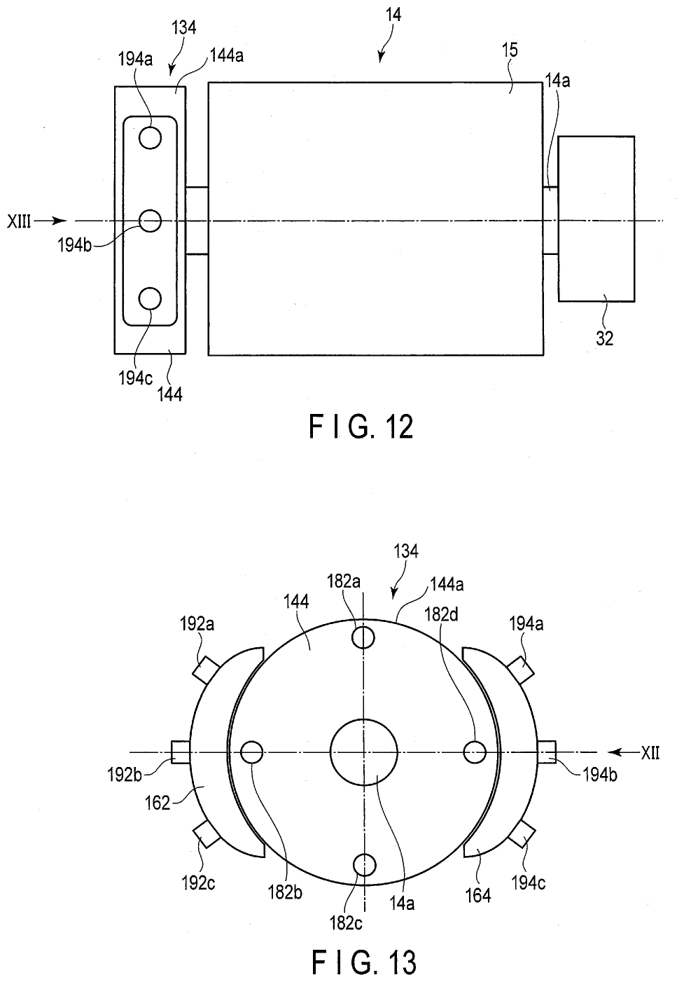

A hoisting machine 14 of an elevator (elevating machine) 10 according to the second embodiment will be described with reference to FIGS. 12 and 13. In the first embodiment, an example in which the brake apparatus 34 for the hoisting machine 14 is a disc brake has been described. A brake apparatus 134 of the hoisting machine 14 according to the present embodiment will be described as a drum brake.

In the present embodiment, the description of the same contents as those described in the first embodiment will be omitted as appropriate.

The elevator maintenance system 94 according to the present embodiment can use the state estimation system 80 of the brake apparatus 34 for the hoisting machine 14 described in the first embodiment.

FIG. 12 is a schematic diagram illustrating a part of the brake apparatus (drum brake) 134 for the hoisting machine 14 for an elevator 10 according to the second embodiment as viewed from a direction indicated by reference sign XIII in FIG. 13. FIG. 13 is a schematic diagram of the brake apparatus 134 as viewed from a direction indicated by an arrow XIII in FIG. 12.

As illustrated in FIGS. 12 and 13, the brake apparatus 134 includes a drum 144 that is provided on the rotation shaft 14a and rotates together with the rotation shaft 14a, and a pair of brake shoes 162 and 164 that press the outer peripheral surface of the drum 144 from the outside toward the central axis, for example. A brake lining 144a is attached to the outer peripheral surface of the drum 144.

The brake shoes 162 and 164 are operated in conjunction with each other using, for example, hydraulic pressure or the like. Normally, the brake shoes 162 and 164 hold the brake lining 144a on the outer peripheral surface of the drum 144 so as to sandwich the drum 144. In a case where the rotation of the rotation shaft 14a is permitted, the state in which the drum 144 is sandwiched by the brake shoes 162 and 164 is released.

A control apparatus 22 outputs the waveform information using sensors 192a to 192c and 194a to 194c attached to the brake shoes 162 and 164 using the start of movement of the brake shoes 162 and 164 so as to sandwich the drum 144 with the brake shoes 162 and 164 as a trigger signal.

In the drum 144, it is also preferable that sensors 182a to 182d are provided at positions away from the brake shoes 162 and 164. The control apparatus 22 outputs the waveform information using the sensors 182a to 182d attached to the drum 144 using the start of movement of the brake shoes 162 and 164 so as to sandwich the drum 144 with the brake shoes 162 and 164 as a trigger signal. In this case, the drum 144 rotates. Therefore, the sensors 182a to 182d may rotate together with the rotation shaft 14a and the drum 144.

Also in this case, as described in the first embodiment, the processor 82 of the management server 80a can estimate the contact state between the first brake shoe (pad) 162 and the drum (metal body) 144 and the contact state between the second brake shoe (pad) 164 and the drum (metal body) 144 by taking the difference between the waveform information acquired by each of the sensors 182a to 182d, 192a to 192c, and 194a to 194c and the reference data. Specifically, the surface state of the brake shoe 162 and the contact state between the brake shoe 162 and the lining 144a of the drum 144 can be estimated based on the waveform information acquired by the sensors 182a to 182c and 192a to 192c. The surface state of the brake shoe 164 and the contact state between the brake shoe 164 and the lining 144a of the drum 144 can be estimated based on the waveform information acquired by the sensors 182a, 182c, 182d, and 194a to 194c. That is, the management server 80a can estimate at least one of the surface state of the brake material, the surface state of the metal plate, and the contact state between the brake material and the metal plate.

In this manner, the processor 82 of the management server 80a can obtain the information regarding the brake apparatus 134 of the hoisting machine 14 of the elevator 10 every time the car 16 of the elevator 10 stops and repeatedly estimate the state of the brake apparatus 134.

In the present embodiment, from the time of installation of the hoisting machine 14 or replacement of the brake apparatus 134 in the elevator 10, the plurality of sensors 182a to 182d are installed on the drum 144, which is a metal body in contact with the brake pads (friction materials) 162 and 164 of the brake apparatus 134, or the plurality of sensors 192a to 192c and 194a to 194c are installed on the brake shoes 162 and 164. In a case where the car 16 reaches a predetermined floor and the brake is operated, an elastic wave generated by solid contact between the brake shoes 162 and 164 and the drum 144 is recorded. Then, the feature amounts of these elastic waves acquired and recorded by the sensors 192a to 192c and 194a to 194c are compared with the reference data at the time of installation of the hoisting machine 14 or replacement of the brake apparatus 134. As a result, according to the present embodiment, it is possible to estimate the state of the brake apparatus 134 and evaluate the state of the brake apparatus 134 every time the brake apparatus 134 is turned on/off, which is a steady operation, without requiring an unsteady brake braking operation.

According to the present embodiment, it is possible to provide the state estimation apparatus 80a of the brake apparatus 134 for the hoisting machine 14, the state estimation system 80, the brake system 92 for the hoisting machine 14, the elevator maintenance system 94, the non-transitory storage medium configured to store a state estimation program, and the state estimation method capable of grasping the deterioration in performance over time, the inspection timing, and the replacement timing of the brake apparatus 134 for the hoisting machine 14 used in the elevator 10 so as to maintain the brake apparatus 134 such as inspecting and replacing the brake apparatus 134 before the holding/braking torque of the brake apparatus 134 of the hoisting machine 14 of the elevator 10 falls below a reference value (safety line).

According to at least one of the embodiments described above, it is possible to provide the state estimation apparatus 80a of the brake apparatus 34, 134 for the hoisting machine 14, the state estimation system 80, the brake system 92 for the hoisting machine 14, the elevator maintenance system 94, the non-transitory storage medium configured to store a state estimation program, and the state estimation method capable of grasping the deterioration in performance over time, the inspection timing, and the replacement timing of the brake apparatus 34, 134 for the hoisting machine 14 used in the elevator 10 so as to maintain the brake apparatus 34, 134 such as inspecting and replacing the brake apparatus 34, 134 before the holding/braking torque of the brake apparatus 34, 134 of the hoisting machine 14 of the elevator 10 falls below a reference value (safety line).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A state estimation apparatus for a brake apparatus for a hoisting machine, the state estimation apparatus comprising a processor that is configured to:
acquire waveform information of an elastic wave generated in a case where a brake material fixed to a brake plate connected to a rotation shaft of the hoisting machine and a metal plate holding the brake material and restraining movement of the brake plate come into contact with each other using a sensor provided on the metal plate; and
estimate at least one of a surface state of the brake material, a surface state of the metal plate, and a contact state between the brake material and the metal plate based on a feature amount of the waveform information.

2. The state estimation apparatus according to claim 1, wherein the processor is configured to estimate the contact state between the brake material and the metal plate from a difference from reference data acquired at the time of installation of the hoisting machine or replacement of the brake apparatus, based on a magnitude of an amplitude and a frequency of the elastic wave acquired by the sensor as the feature amount of the waveform information of the elastic wave.

3. The state estimation apparatus according to claim 2, wherein, as the feature amount of the waveform information of the elastic wave,
the amplitude of the elastic wave is smaller than an amplitude of the reference data, and
the frequency of the elastic wave is higher than a frequency of the reference data.

4. The state estimation apparatus according to claim 1, wherein the processor is configured to:
accumulate the waveform information, and
compare a difference between the waveform information and reference data acquired at the time of installation of the hoisting machine or replacement of the brake apparatus.

5. The state estimation apparatus according to claim 4, wherein the processor is configured to determine whether a state of the brake material has changed or whether the state of the brake material or a state of the metal plate has changed, based on continuity of the accumulated waveform information.

6. A state estimation system for a brake apparatus for a hoisting machine, the state estimation system comprising:
a sensor provided on a metal plate that is configured to come into contact with a brake material fixed to a brake plate connected to a rotation shaft of the hoisting machine and is configured to restrain movement of the brake plate; and
the state estimation apparatus according to claim 1.

7. The state estimation system according to claim 6, wherein the sensor is an AE sensor or a vibration sensor.

8. A brake system for a hoisting machine, comprising:
a brake plate connected to a rotation shaft of the hoisting machine;
a brake material fixed to the brake plate;
a metal plate that is configured to hold the brake material and is configured to restrain movement of the brake plate; and
the state estimation system for a brake apparatus for a hoisting machine according to claim 6.

9. An elevator maintenance system comprising the brake system for a hoisting machine according to claim 8.

10. A non-transitory storage medium that stores a state estimation program of a brake apparatus for a hoisting machine, the state estimation program causing a computer to execute:
acquire waveform information of an elastic wave generated in a case where a brake material fixed to a brake plate connected to a rotation shaft of the hoisting machine and a metal plate holding the brake material and restraining movement of the brake plate come into contact with each other using a sensor provided on the metal plate; and
estimate at least one of a surface state of the brake material, a surface state of the metal plate, and a contact state between the brake material and the metal plate based on a feature amount of the waveform information.

11. A state estimation method for a brake apparatus for a hoisting machine, the state estimation method comprising:
acquiring waveform information of an elastic wave generated in a case where a brake material fixed to a brake plate connected to a rotation shaft of the hoisting machine and a metal plate holding the brake material and restraining movement of the brake plate come into contact with each other using a sensor provided on the metal plate; and
estimating at least one of a surface state of the brake material, a surface state of the metal plate, and a contact state between the brake material and the metal plate based on a feature amount of the waveform information.
